(19) United States
(12) Patent Application Publication
(10) Pub. No.: US 2017/0147323 A1
(43) Pub. Date: May 25, 2017

(54) METHOD AND ELECTRONIC DEVICE FOR UPGRADING SOFTWARE DEVELOPMENT KIT OF AN APPLICATION

(71) Applicants: LE HOLDING (BEIJING) CO., LTD., BEIJING (CN); LECLOUD COMPUTING CO., LTD., BEIJING (CN)

(72) Inventors: YUEFENG HU, BEIJING (CN); YAFENG XU, BEIJING (CN); DI HOU, BEIJING (CN); YESHUAI PAN, BEIJING (CN)

(21) Appl. No.: 15/248,796

(22) Filed: Aug. 26, 2016

Related U.S. Application Data
(63) Continuation of application No. PCT/CN2016/083037, filed on May 23, 2016.

(30) Foreign Application Priority Data
Nov. 25, 2015 (CN) 201510829698.2

(51) Int. Cl. G06F 9/445; H04L 29/08

(52) U.S. Cl. CPC G06F 8/65; H04L 67/10

(57) ABSTRACT

Disclosed are a method and electronic device for upgrading a software development kit (SDK) of an application. The method includes, at a cloud server: configuring, by the cloud server, service modules and service configuration files of the SDK; upgrading, by the cloud server, the service modules and the service configuration files of the SDK; receiving, by the cloud server, an interaction request sent by the application, and parsing, by the cloud server, a system type of the application and a version of the SDK; and sending, by the cloud server, the service modules and/or the service configuration files to a terminal including the SDK based on the system type of the application and the version of the SDK, and upgrading, by the cloud server, the SDK of the application. By applying the method and electronic device of the present application, the SDKs of applications may be upgraded automatically.

### CROSS REFERENCE TO RELATED APPLICATIONS

This application is a continuation of International Application No. PCT/CN2016/083037, filed on May 23, 2016, which is based upon and claims priority to Chinese Patent Application No. 201510829698.2, filed on Nov. 25, 2015, the entire contents of each of which are incorporated herein by reference.

### TECHNICAL FIELD

The disclosure relates to upgrading applications of smart terminals, and in particular to a method and electronic device for upgrading a software development kit (SDK) of an application.

### BACKGROUND

At present, operating systems of smart devices mainly include iOS and Android. Due to rapid development of Internet applications, a software development kit (SDK) based on these two systems requires frequent upgrading, so as to meet the user demands and to provide an improved user experience.

For the smart terminals based on either the iOS or the Android system, it is very difficult to update developed SDKs. The upgrading requires providing a new SDK and embedding the same into the application (APP), and then downloading a new APP by the user through the smart terminal, which may cause great inconvenience. In the present market, 95% of applications have such SDK upgrading problems. Therefore, in the industry, there is an urgent need of a solution for automatically upgrading the SDK of the application, so as to make the upgrading of the SDK convenient and fast.

### SUMMARY

The disclosure provides a method and electronic device for upgrading a software development kit (SDK) of an application to address the technical problem in the prior art, i.e., that the upgrading of SDKs in existing smart terminals is difficult, so as to facilitate remote and automatic upgrading of SDKs in smart terminals.

An embodiment of the disclosure provides a method for upgrading a software development kit (SDK) of an application, which includes, at a cloud server:

Configuring, by the cloud server, service modules and service configuration files of the SDK;

Renewing, by the cloud server, the service modules and the service configuration files of the SDK;

Receiving, by the cloud server, an interaction request sent by the application, and parsing, by the cloud server, a system type of the application and a version of the SDK; and

Sending, by the cloud server, the service modules and/or the service configuration files to a terminal including the SDK based on the system type of the application and the version of the SDK, and upgrading, by the cloud server, the SDK of the application.

Another embodiment of the disclosure provides an electronic device for upgrading a software development kit (SDK) of an application, including: at least one processor; and a memory communicably connected with the at least one processor configured to store instructions executable by the at least one processor, wherein execution of the instructions by the at least one processor causes the at least one processor to execute the method for upgrading a software development kit (SDK) of an application mentioned above.

Yet another embodiment of the disclosure provides a non-transitory computer-readable storage medium storing executable instructions that, when executed by an electronic device, cause the electronic device to execute the method for upgrading a software development kit (SDK) of an application mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for upgrading an SDK of an application according to an embodiment of the disclosure;

FIG. 2 is a flow chart of a transplanting method for service modules of an SDK according to an embodiment of the disclosure;

FIG. 3 is a flow chart of a method for upgrading an SDK of an application in an iOS terminal according to an embodiment of the disclosure;

FIG. 4 is a flow chart of a method for upgrading an SDK of an application in an Android terminal according to an embodiment of the disclosure;

FIG. 5 is a frame structural diagram of a system for upgrading an SDK of an application in the disclosure;

FIG. 6 is a structural diagram of a method and a system for executing an embodiment of the disclosure; and

FIG. 7 is a structural schematic diagram of a server 700 for executing the upgrading method of an embodiment of the disclosure.

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but do not include all possible not all embodiments. Based on the embodiments of the disclosure, other embodiments obtained by the ordinary skill in the art without undue experimentation are within the scope of the disclosure.

The disclosure is directed to a problem of difficulty in version upgrading caused by the fact that SDKs in the application in the industry may not be automatically updated, service modules of the SDKs are transplanted to a cloud server, and the SDKs mounted in the terminal are updated and controlled in the cloud server, thereby realizing automatic upgrading of SDKs in the terminal and simplifying the upgrading process of SDKs.

Since the system of smart terminals generally provides an external standard program interface based on a standard program interface provided by an operating system of the terminal and programming languages supported by the operating system, the service modules of an SDK are realized by the corresponding programming language and are placed in the cloud server. Thus, a standard service interface API allowing the terminal to access is provided. The terminal may access the service content by the standard interface API provided by the service modules, thereby transplanting the service modules of the SDK. Hence, after the service is transplanted to the cloud server, the terminal only needs to store the information of function modules such as device information (model, etc.), decoder (soft decoding), and the like that may be realized through system calling for the specific service content.

In various embodiments, the service modules may be updated by docking with an API, thereby realizing the upgrading of the SDK and meeting the frequent upgrading requirements of the SDK. Based on service needs, when the SDK is updated, only the content of the service modules needs to be modified in the cloud server, and a corresponding service profile (namely a realizing file, such as a JavaScript file, for example, of the compiled service module) is updated. Then, the terminal is controlled to download new service modules in a case of upgrading requirements based on a configuring request of the terminal application, and automatic upgrading of the SDK is realized. The method for upgrading the SDK of the disclosure is realized by transplanting the service modules to the cloud server. The upgrading of the service modules is realized by downloading and upgrading a file in real time based on the request of the terminal and the service needs. Therefore, upgrading of the APP is not required, it is not necessary to rely on the upgrading of the SDK on the APP, there is no need to specifically download a new SDK and a new APP, and the upgrading process is very quick and simple.

In an embodiment, the system of the terminal may be implemented as a current universal mobile terminal system, such as iOS, Android, etc., and the programming language may be JavaScript supported by both iOS and Android. Since both iOS and Android terminals have a common API with JavaScript, and the service modules may be well transplanted by jointing the terminal systems and a standard interface of the JavaScript. As an illustrative example a programming language for service module transplanting is JavaScript and the terminal is the iOS terminal or Android terminal, and the disclosure in combination with the drawings provided herein further explains the details of the operation of the system.

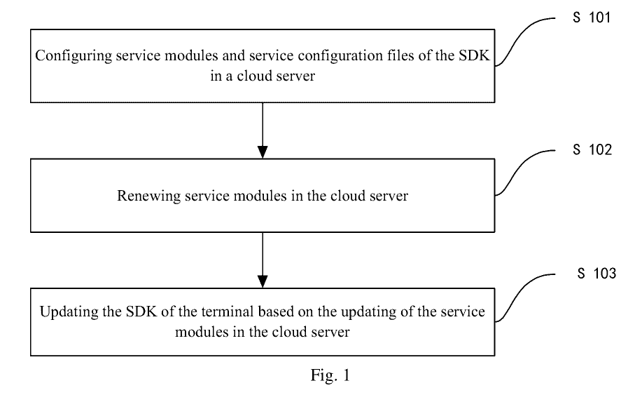

FIG. 1 is a flow chart of a method for upgrading an SDK of an application according to an embodiment of the disclosure. FIG. 1 schematically shows a method for upgrading an SDK of an application of one embodiment according to the disclosure. In an embodiment, the method may include the following steps, as shown in FIG. 1.

Step S101: service modules and service configuration files of the SDK are configured in a cloud server.

For example, embodiments include standardized data structures being defined based on interface standards of an operating system. After the standard structures are defined, JavaScript is then used for programming in the cloud server to realize the service modules of the SDK, and the generated corresponding service configuration files (namely the generated JavaScript files) are stored in the cloud server. Furthermore, the data interface API accessing the service modules is provided for the terminal, and the data interacting with the terminal is standardized based on the defined structure. Therefore, the SDK of the terminal may access the service modules by the API provided by the JavaScript file to input parameters of a request to the service module and receive a standard data result returned after processing by the service modules. Additionally, the SDK of the terminal may perform processing on the retuned standard data result based on service needs without having to determine the specific content of the service modules. As a result of performing the service transplanting and the API accessing functions when the service is modified, only the content of the service modules is correspondingly modified, and the content of the whole SDK is not modified, thereby realizing the single upgrading of the SDK in the application.

Step S102: service modules are renewed in the cloud server.

According to service needs (for example, the data structure of the server is changed, or one more module is requested), the content of the JavaScript file is correspondingly modified (by programming) to update the service module, and the modified service modules and the corresponding service configuration files (for example the JavaScript file) are updated in the cloud server.

Step S103: the SDK of the terminal is updated based on the updating of the service modules in the cloud server.

When the application on the terminal is opened, the application of the terminal interacts with the cloud server at a first time, and performs the newest configuring request of the SDK on the cloud server. The cloud server controls the SDK of the terminal to be updated based on the configuration request and the service needs of the terminal, wherein the configuring request includes system types (for example iOS or Android) of the application and a current version of the SDK, etc. Based on the system model of the application and the version of the SDK, the cloud server sends an upgrading instruction to the terminal of the SDK to update the SDK in the application. Based on the control of the cloud server, the terminal acquires the newest service modules and/or service configuration file (JavaScript file) when the SDK mounted earlier needs to be upgraded and/or updated. Therefore, based on the control and updating of the cloud server, the SDK on the terminal may be automatically separately upgraded without updating the application.

Based on different characteristics of the operating system of the terminal, specific implementing methods for interaction between the terminal and the cloud server interact to automatically update the SDK on the terminal are different. For ease of explanation, the terminal of the iOS system and of the Android system will be used as an example and the various embodiments are described in combination with the figures.

In an embodiment, the service modules transplanted to the cloud server may be customized and realized based on service needs and terminal characteristics. For example, for the iOS terminal, the service modules may be more than 80% of advertising, statistics, UI composition, service side request sending, data standardization, and adaptation function modules. These service modules are realized by the JavaScript language adaptive to the system. To provide another example, for the Android terminal, the Android system supports the plug-in per se, and the service modules transplanted to the cloud server may be a plug-in service management module corresponding to all modules of the SDK of the terminal. That is, each module of the SDK of the Android terminal is transplanted to the cloud server in a plug-in manner. By loading a plug-in in a match version in real time (or nearly real time), automatic upgrading of the corresponding service modules may be realized.

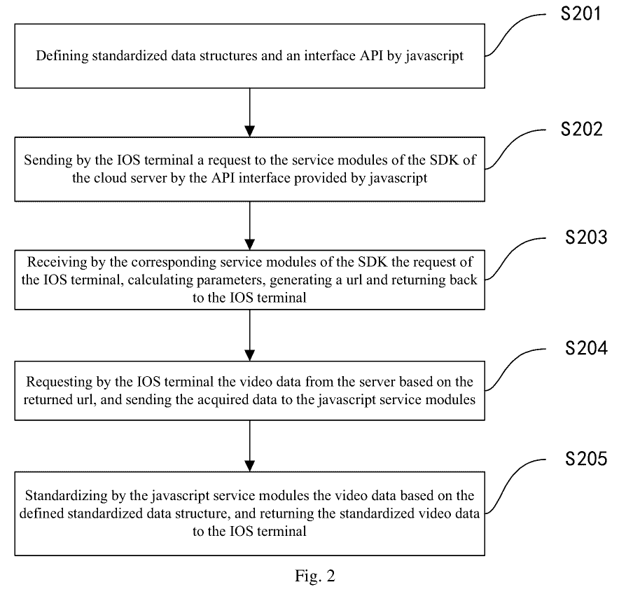

FIG. 2 is a flow chart of a transplanting method for service modules of an SDK according to an embodiment of the disclosure. In the example shown in FIG. 2, the terminal is an iOS terminal, the SDK is a playing SDK, and the content of the service module is a service side request for acquiring video data by the iOS terminal to request a server medium interface. Continuing this example, the method as shown in FIG. 2 includes the following steps.

Step S201: standardized data structures and an interface API are defined by JavaScript.

The standardized data structures are defined based on the interface standard of the iOS. The service modules of the service side request are subject to JavaScript programming in the cloud server by the common API provided by the iOS, and the data output by the service modules is standardized by the standardized data structures so as to return standardized service processing result data by the docking interface API of the iOS and JavaScript. The corresponding JavaScript file that is generated by programming realizes the corresponding service function placed in the cloud server.

Step S202: the iOS terminal sends a request to the service modules of the SDK of the cloud server by the API interface provided by JavaScript.

The corresponding SDK is configured in the iOS terminal. The SDK configured in the iOS terminal includes system level realizing modules and a JavaScript file corresponding to the service module. The system level realizing modules are modules that are realized by relying only on system functions, such as device information and soft decoding, etc. When the iOS terminal submits a processing request of a medium interface of a server, the iOS terminal calls the corresponding service modules by the corresponding API provided by JavaScript.

Step S203: the corresponding service modules of the cloud server receive the request of the iOS terminal, calculate parameters, generate a url, and return the url to the iOS terminal.

After the service modules requested by the service side (namely the JavaScript) receive the request of the iOS terminal, request messages (including an SDK version, a terminal type, a service ID, etc.) are spliced into parameters (username or service line) requested by the server based on information calculating parameters in the request sent from the iOS terminal, and an address of a url requesting video data is generated and returned to the iOS terminal by the corresponding API.

Step S204: the iOS terminal requests the video data from the server based on the returned url, and sends the acquired data to the JavaScript service modules of the cloud server.

The iOS system has a common network request module. After the terminal receives the url returned by the JavaScript service module, the iOS system requests the video data of the address indicated by the url from the server through the network request module. After the iOS terminal acquires the data returned by the server, the data is sent directly to the JavaScript realizing service modules (namely the service modules of the service end request in this embodiment) by API calling without any processing thereof.

Step S205: the JavaScript service modules of the cloud server standardize the video data based on the defined standardized data structure, and return the standardized video data to the iOS terminal.

After receiving the video data sent from the iOS terminal, the service modules standardize the video data based on the defined data structures, and return the standardized data to the iOS terminal according to the jointed API interface. After receiving the standardized data, the iOS terminal performs subsequent processing such as output to display, etc.

By using the method including steps S201-S205, the iOS terminal does not need to determine any service processing content, but only needs to process the standardized data returned by the service module. When the server has a data structure change or service logic change, only the logic and content of the service modules of the service side request are required to be modified. Furthermore, the JavaScript file of the SDK of the iOS terminal are updated without corresponding modification on the content of the SDK of the iOS terminal, which can offer a great convenience. It should be noted that in this embodiment, the iOS terminal sends the video data request to the server, and then the data is acquired and is returned to the JavaScript service modules for standardizing processing rather than the JavaScript service modules directly requesting the data from the server after splicing the url. Although both aforementioned techniques will obtain the same result from the request for data from the server, the request through the iOS terminal has relatively good performance, and may save data returning time. For example, if the iOS terminal requests data from the server, data may be acquired on the order of 3 ms, while time on the order of 10 ms is required for a request via JavaScript.

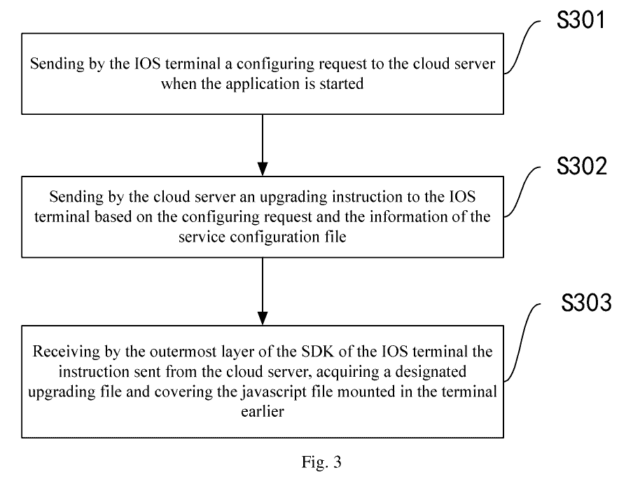

FIG. 3 is a flow chart of a method for upgrading an SDK of an application in an IOS terminal according to an embodiment of the disclosure. In an embodiment, the method includes the following steps, as shown in FIG. 3.

Step S301: the iOS terminal sends a configuring request to the cloud server when the application is started.

When the application on the iOS terminal is started, the iOS terminal sends request information for acquiring the newest configuration to the cloud server at first, wherein the configuring request includes the system type of the current terminal, the version information, and the service information of the SDK mounted thereon.

Step S302: the cloud server sends an upgrading instruction to the iOS terminal based on the configuring request and the information associated with the service configuration file.

After the cloud server receives the request, the cloud server compares the system types, the SDK version information, and the service information in the configuring request to the file version and the service updating information of the service modules stored in the cloud server. When the cloud server, as a result of this comparison, finds they are inconsistent (for example, when a new function or service adjusting exists), the cloud server sends a compulsory upgrading instruction to the outermost layer of the SKD of the iOS terminal (namely the APP of the SDK). The upgrading instruction includes information such as the version and downloading address of the JavaScript file corresponding to the service module.

Step S303: the outermost layer of the SDK of the iOS terminal receives the instruction sent from the cloud server, acquires a designated upgrading file, and covers the JavaScript file mounted in the terminal earlier.

After receiving the compulsory upgrading instruction sent from the cloud server, the outermost layer (the application using the SDK) of the SDK of the ISO terminal acquires the corresponding JavaScript file from the cloud server based on the designated address and version, and covers the JavaScript file downloaded earlier by downloading the new JavaScript file, so as to finish an automatic upgrading.

By using the above method, compulsory upgrading of the SDK in the ISO terminal is facilitated, with the upgrading being controlled by the cloud server. In this way, only the service configuration file is required to be updated in the cloud server based on the service needs without the need to modify the entire SDK. As a result, the upgrading of the APP is not required, thereby yielding a simple, convenient, and fast process.

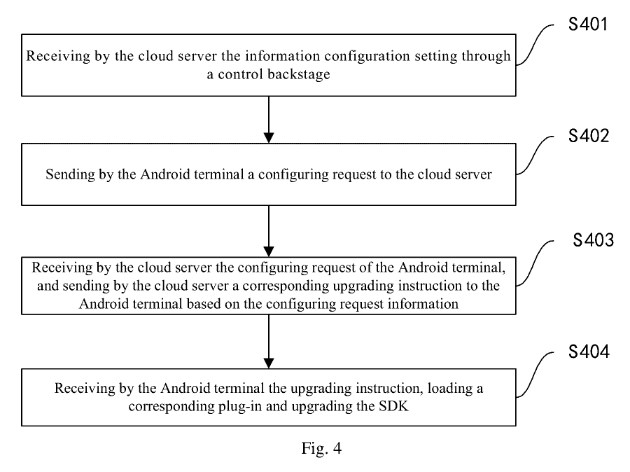

FIG. 4 is a flow chart of a method for upgrading an SDK of an application in an Android terminal according to an embodiment of the disclosure. In an embodiment, the method includes the following steps, as shown in FIG. 4.

Step S401: the cloud server receives the information configuration setting through a background control.

According to the modularized characteristic of the Android system, the service modules may be subjected to plug-in management to realize the oriented upgrading of the SDK by the Android terminal controlled by the cloud server. Specifically, the cloud server provides a control in the background for configuration setting. An administrator may update the content of the service modules and perform upgrading configuration setting on the SDK of the Android terminal based on the service needs, for example, to designate a version requiring updating, a version requiring roll back, a region requiring upgrading, etc. After the configuration setting, the cloud server controls the Android terminal to perform oriented upgrading corresponding to the configuring based on the configuration information of the Android terminal.

Step S402: the Android terminal sends a configuring request to the cloud server.

When the application on the Android terminal is started, the Android terminal sends the mated configuring request to the cloud server at first, wherein the configuring request includes the corresponding information such as system type, device model, located region, the SDK version of the current application, service module, etc., of the terminal.

Step S403: the cloud server receives the configuring request of the Android terminal, and sends a corresponding upgrading instruction to the Android terminal based on the configuring request information.

After the cloud server receives the configuring request, the cloud server judges whether to update the SDK of the terminal based on the terminal information in the configuring request and the configuration information already set, and sends the corresponding upgrading instruction to the Android terminal, wherein the upgrading instruction includes setting information such as the version and the service modules requiring updating, the version and the service modules requiring rollback, or the version and the service modules of which designated addresses require updating.

Step S404: the Android terminal receives the upgrading instruction, loads a corresponding plug-in, and updates the SDK.

After receiving the upgrading instruction, the Android terminal downloads the plug-in of the corresponding module from the cloud server based on the configuration information in the upgrading instruction, and loads it to the application (that is, downloads the plug-in service management module corresponding to the module requiring upgrading and corresponding configuration files thereof). In this way, terminal configuring is realized based on the cloud server, and the corresponding updating is performed on the SDK in the terminal.

According to the above method, the configuration upgrading of the SDK in the Android terminal is finished. The updating is controlled by the configuration information of the cloud server. Real-time (or near real-time) loading and updating are performed by plug-in. Thus, the process is simple, convenient and fast, and oriented updating may also be realized, which enhances practicability.

Therefore, according to the above method of the disclosure, when data structures or service needs of the server are changed, only logic modifying through JavaScript is required, and the modified JavaScript file is uploaded to the cloud. The terminal performs no processing, but only needs to download the newest JavaScript file based on an upgrading instruction of the cloud server upon each request, and the service content called by the API is just the latest version. The service is transplanted to the cloud server, and the upgrading on the terminal SDK is converted to the upgrading on the service module. The device terminal may thus only be directed to performing post-treatment on the returned standard data, and the upgrading therefore becomes very convenient. By using the embodiments described herein, based on service needs, more than 80% of service functions of the SDK in the iOS terminal may be realized by JavaScript and are transplanted to the cloud server, thereby finishing the remote automatic upgrading on more than 80% functions of the SDK of the iOS system. Since the Android system is divided into modules and supports plug-in upgrading, using the embodiments described herein, based on the service needs, each service module of the SDK of the Android system may be transplanted to the cloud server, and the SDK of the Android system may be subjected to plug-in oriented upgrading.

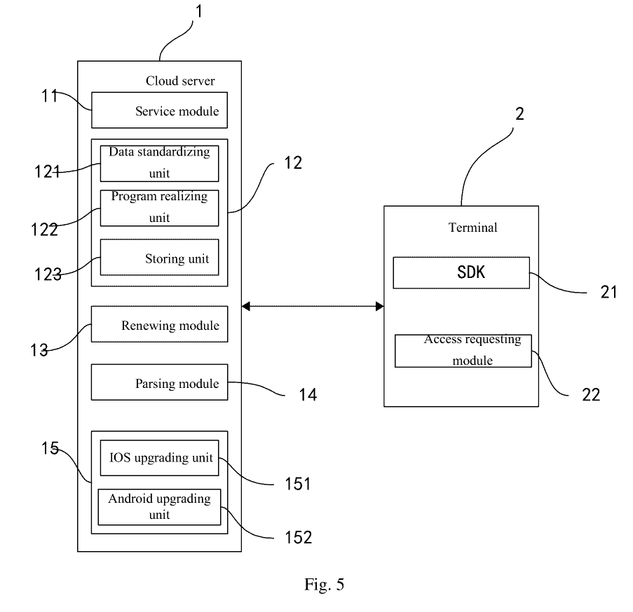

FIG. 5 is a frame structural diagram of a system for upgrading an SDK of an application in the disclosure. As shown in FIG. 5, the system is configured on a cloud server 1, which includes a configuring module 12, a renewing module 13, a parsing module 14, and an upgrading module 15. The configuring module 12 may be configured to configure service modules 11 and service configuration files of the SDK in the cloud server 1. The renewing module 13 may be configured to renew the service modules 11 and the service configuration files configured by the configuring module based on service needs. The parsing module 14 may be configured to receive an interaction request sent by the application, and parse a system type of the application and a version of the SDK based on a configuring request of the application of the terminal. The upgrading module 15 may be configured to send the service modules and/or the service configuration files renewed by the renewing module 13 to a terminal 2 including the SDK based on the system type of the application and the version of the SDK to upgrade the SDK of the application.

In an embodiment, configuring module 12 includes a data standardizing unit 121, a program realizing unit 122, and a storing unit 123. Data standardizing unit 121 may be configured to define standardized data structures based on interface standards of an operating system corresponding to the application. Program realizing unit 122 may be configured to realize the service modules of the SDK, to generate the service configuration files using languages supported by the operating system corresponding to the application, and to utilize the standardized data structures defined by the program realizing unit. Storing unit 123 may be configured to store the service modules realized by the program realizing unit and the service configuration files in the cloud server.

Service modules 11 in the cloud server 1 may be realized by the programming languages supported by the operating system of the terminal based on the interface standards of the operating system of the terminal. The operating system of the terminal 2 of the embodiment of the disclosure may be, for example, an iOS system or Android system of a smart terminal. Accordingly, the programming language may include JavaScript supported by the iOS system and Android system, which provides an interface API. The service of the SDK is realized by the JavaScript to transplant the service module to the cloud server 1. In an embodiment, for the iOS terminal, the service module 11 uses the JavaScript language to realize the service modules adaptive to the iOS system, including advertising, performing statistics, performing UI composition, performing adaptation, sending a service side request and performing data standardization, and the corresponding service configuration file is a JavaScript file generated after programming.

In another embodiment, for the Android terminal, the service modules 1 realize the plug-in service management module corresponding to each module of the application of the Android system using the JavaScript language, and the service configuration file is a file corresponding to the plug-in. Adaptation of the service modules 11 to the terminal system includes defining the standardized data structures by JavaScript based on the interface standards of the terminal system, standardizing the data of the service processing by the standardized data structures, and then returning to the terminal by providing a standardized data interface API.

In an embodiment, the upgrading system of the SDK is configured on the cloud server, which may be implemented, for example, as a server or a server cluster, wherein each module may be a single server or server cluster. In accordance with such embodiments, interactions among the modules are implemented as interactions among the servers or server clusters corresponding to respective modules, and the servers or server clusters together constitute the upgrading system of the SDK of the application of the disclosure.

In an embodiment, the upgrading system of the SDK of the application of the disclosure constituted by the servers or server clusters includes:

a configuring server or server cluster 12, a renewing server or server cluster 13, a parsing server or server cluster 14, and an upgrading server or server cluster 15. The configuring server or server cluster 12 may be configured to configure service server or server clusters 11 and service configuration files of the SDK in an upgrading management center 1 in the cloud server. The renewing server or server cluster 13 may be configured to renew the service server or server clusters 11 and the service configuration files configured by the configuring server or server cluster 12 based on service needs. The parsing server or server cluster 14 may be configured to receive an interaction request sent by the application, and to parse a system type of the application and a version of the SDK based on a configuring request of the application of the terminal. The upgrading server or server cluster 15 may be configured to send the service server or server clusters and/or the service configuration files renewed by the renewing server or server cluster 13 to a terminal 2 including the SDK based on the system type of the application and the version of the SDK, and to upgrade the SDK of the application.

In an alternate embodiment, one server or server cluster may be constituted by a plurality of above modules together. For example, configuring module 12 and renewing module 13 may constitute a first server or first server cluster, parsing module 14 may constitute a second server or second server cluster, and upgrading module 15 may constitute a third server or third server cluster.

In this case, the interactions among the modules are interactions among the first to third servers or the interaction among the first to third server clusters, and the first to third servers or the first to third server clusters together constitute the system for upgrading the SDK of the application of the disclosure.

Further in accordance with this embodiment, configuring module 12 may constitute one server or server cluster, wherein each unit may be a single server or server cluster. In such a case, the interaction among the units is presented by the interaction among the servers or server clusters corresponding to respective units, and the servers or server clusters constitute the configuring module 12 to form the system for upgrading the SDK of the application of the disclosure together.

In an alternate embodiment, several of the units (which may include any suitable number or all units) may constitute one server or server cluster together.

As shown in FIG. 5, terminal 2 includes an SDK 21 and an access requesting module 22. To provide an illustrative example of a specific application, when the application using the SDK 21 on terminal 2 is started, terminal 2 acquires the version information and service information of the SDK 21 through the access requesting module 22, generates a configuring request including a terminal system type and SDK version information, and sends the configuring request to cloud server 1 to realize the upgrading of the SDK in the application. Parsing module 14 in cloud server 1 parses the terminal system type and the SDK version information according to the configuring request sent from the terminal 2. The upgrading module 15 judges based on the SDK version information parsed by the parsing module and the information of the service configuration file stored in the cloud server, and outputs an upgrading instruction to the terminal based on the terminal system type when an upgrading is necessary (for example, when the version is inconsistent or the service is adjusted), to facilitate updating the SDK.

In an embodiment, upgrading module 15 includes an iOS upgrading unit 151 and an Android upgrading unit 152. The iOS upgrading unit 151 may be configured such that when the system type of the application is iOS, cloud server 1 sends the JavaScript file to an iOS terminal including the SDK to upgrade the SDK of the application. The Android upgrading unit 152 may be configured such that when the system type of the application is Android, cloud server 1 sends the plug-in service management module and the profile to an Android terminal including the SDK to upgrade the SDK of the application.

In an embodiment, upgrading module 15 may be a server or server cluster, wherein the iOS upgrading unit 151 and the Android upgrading unit 152 may be a single server or server cluster. In such a case, interactions between the iOS upgrading unit 151 and the Android upgrading unit 152 are interactions between the servers or the server clusters corresponding to respective units.

In an alternate embodiment, one or two of the iOS upgrading unit 151 and the Android upgrading unit 152 constitute one server or server cluster together. With respect to the iOS terminal, cloud sever 1 sends an upgrading instruction to the application in the terminal by iOS upgrading unit 151 and the application of the terminal acquires the JavaScript file to perform SDK upgrading according to the upgrading instruction. The upgrading instruction includes the version and downloading address of the service configuration file (namely the JavaScript file) requiring upgrading. Specifically, when a user opens an SDK related application via the iOS terminal, the related application on iOS terminal 2 sends a configuring processing request containing the system type and the version information of the currently used SDK to cloud server 1. Parsing module 14 parses the configuring request sent from iOS terminal 2.

When the system type is iOS, iOS upgrading unit 151 compares the current version information of the SDK acquired from iOS terminal 2 with the service modules stored on cloud server 1. When the version information is inconsistent, the upgrading instruction is sent to the corresponding application using the SDK on iOS terminal 2. The application on iOS terminal 2 downloads the JavaScript file of the latest version from cloud server 1 to iOS terminal 2 based on the received upgrading instruction. The iOS terminal 2 covers the JavaScript file mounted earlier with the received JavaScript to finish the upgrading of the SDK.

SDK 21 associated with terminal 2 may realize the access to service modules 11 by the provided API, and may acquire the standardized data. Therefore, terminal 2 may directly perform corresponding operations on the standardized data without performing specific service processing. When cloud server 1 has a data structure change or service logic change, only the corresponding logic and content of the service modules are required to be modified without the need of modifying the SDK of the terminal, and the modified JavaScript file of the service modules 11 are updated in the cloud sever 1. Therefore, service module 11 provides the standardized docking interface, and the application of the terminal downloads the latest JavaScript file to cover the JavaScript file of the current version by the upgrading control instruction of cloud server 1. By updating the JavaScript file of the service modules, the automatic upgrading or upgrading of the SDK in terminal 2 may be realized (that is the content of the API accessed by terminal 2 after the file updating is the most recent).

When the system type is Android, since the Android system per se supports the modularization, each service module of the SDK may be subjected to a plug-in to update the SDK in a plug-in oriented manner. In an embodiment, cloud server 1 may further include a console for setting upgrading configuration information. The modules requiring upgrading may be set in an oriented manner based on the service needs such as, for example, designating the modules requiring upgrading, designating upgrading or rollback version, designating region upgrading, etc. Specifically, when the user opens an SDK related application on Android terminal 2, the related application on terminal 2 sends the file upgrading processing request configured most recently to cloud server 1 by the access requesting module 22. Parsing module 14 parses the configuring request and parses the system type and the SDK version information. For an Android system, Android upgrading unit 152 sends the upgrading instruction to the application of the terminal based on the SDK version information and the set configuration information. The upgrading instruction includes configuration information, and the application of the terminal downloads the plug-in service modules conforming to the corresponding configuration information and the corresponding configuration file from cloud server 1. Android terminal 2 performs service loading using the received plug-in to realize the oriented upgrading on the corresponding modules based on the configuration information.

Since all services are realized in the service modules 11 of cloud server 1 by JavaScript programming, SDK 21 on terminal 2 only needs to call the corresponding service function by the API, and acquires the standard data for subsequent processing without regards to the service process. Therefore, when the services of the server are changed, only the logic of the service modules are required to be correspondingly modified, and the JavaScript files of the service modules are required to be updated at cloud server 1. Android terminal 2 downloads the updated JavaScript file based on the upgrading control instruction of cloud server 1 when opening the related application, and then the upgrading of the SDK may be realized in a quick and convenient manner. The method and system of the disclosure provide novel solution to realize upgrading the SDK of terminal 2. By the operating system of terminal 2 and the standard interface of the JavaScript, the services are transferred to cloud server 1. By using the standard data interface returned by the JavaScript, the service calling of terminal 2 is realized by an API, and the remote automatic upgrading of the SDK is realized based on the control of cloud server 1. Therefore, the upgrading of the SDK is performed in a simple and quick manner, and the relevant problem in the industry is effectively solved.

By applying the method and system for upgrading a SDK of an application of the embodiments of the disclosure, most service modules in a SDK of a smart terminal are transferred to a cloud server based on the service needs. By upgrading the service modules stored in the cloud server, when the application in the smart terminal is started, the SDK in the smart terminal is automatically upgraded, thereby realizing the upgrading of the SDK in the terminal, simplifying the SDK upgrading process, and solving the problem of difficult upgrading of the SDK in the industry.

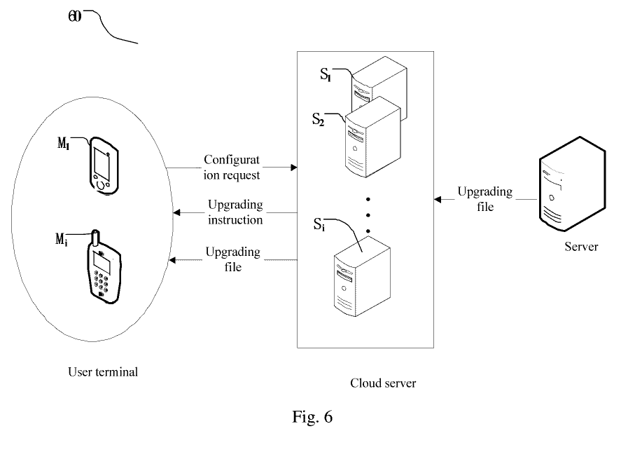

FIG. 6 is a structural diagram of a method and a system for executing an embodiment of the disclosure. In various embodiments, the cloud sever may include any suitable number i of servers S1-Si. For example, when the server has a data structure change or service requirement change, only the service modules are logically modified by JavaScript, and the modified JavaScript is uploaded to the cloud server. The cloud server receives the configuring request sent by any suitable number i of user terminals M1-Mi (smart terminal at least includes Android and iOS), and then executes the upgrading method as shown in FIG. 1 to realize upgrading on the SDK in the terminal.

An embodiment of the present application provides a non-transitory computer-readable storage medium storing executable instructions that, when executed by one or more processors associated with an electronic device, cause the electronic device to execute the method for upgrading a SDK of an application mentioned above.

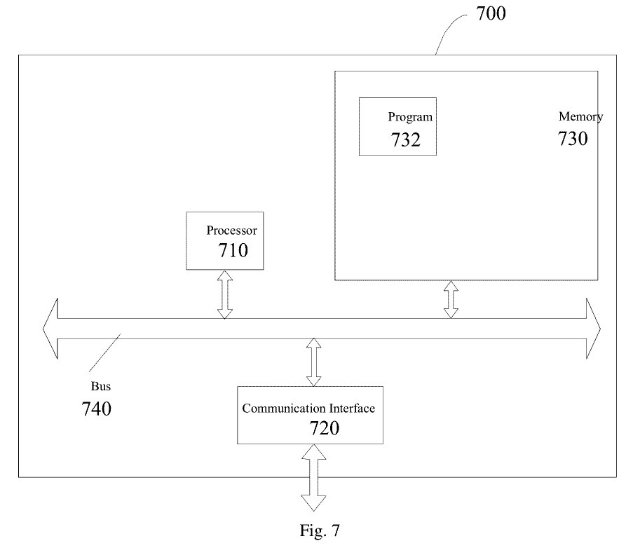

FIG. 7 is a structural schematic diagram of a server 700 for executing the upgrading method of an embodiment of the disclosure. The various embodiment described herein may be implemented via any suitable computing device, such as server 700, for example, but are not limited to such embodiments. As shown in FIG. 7, server 700 includes a processor 701, a communication interface 720, a memory 730, and a communication bus 740.

In an embodiment, processor 701, communication interface 720, and/or memory 730 may communicate with one another via the communication bus 740. Communication interface 720 may be configured to communicate with a network element such as a client end. Processor 710 may be configured to execute a program 732 and, specifically, to execute steps related to the functionality described herein regarding the various embodiments.

For example, program 732 may include a program code, including a computer operation instruction. In various embodiments, processor 710 may be implemented as any suitable number and/or type of processors. For example, processor 710 may be implemented as a central processing unit (CPU), an application specific integrated circuit (ASIC), or may be configured as one or more parts of one or more integrated circuits.

In an embodiment, server 700 may include various components as shown in FIG. 7, which perform the following operations:

memory 730 stores the computer operation instruction;

processor 720 executes the computer operation instruction stored by the memory, to execute the operations of:

configure, by a cloud server (e.g., server 700), service modules and service configuration files of the SDK;

renew, by the cloud server, the service modules and the service configuration files of the SDK;

receive, by the cloud server, an interaction request sent by the application, and parse, by the cloud server, a system type of the application and a version of the SDK; and

send, by the cloud server, the service modules and/or the service configuration files to a terminal including the SDK based on the system type of the application and the version of the SDK, and upgrade, by the cloud server, the SDK of the application.

The foregoing embodiments are illustrative, in which those units described as separate parts may or may not be separated physically. Illustrated components may or may not be physical units, i.e., may be located in one place or distributed in several locations among a network. Some or all modules may be selected according to practical requirement to realize the purpose of the embodiments, and such embodiments can be understood and implemented by the skilled person in the art without undue experimentation.

A person skilled in the art can clearly understand from the above description of embodiments that these embodiments can be implemented through software in conjunction with general-purpose hardware, or directly via hardware implementations. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are provided to describe the technical solutions of the disclosure, but are not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A method for upgrading a software development kit (SDK) of an application at a cloud server, comprising:
configuring, by the cloud server, service modules and service configuration files of the SDK;
renewing, by the cloud server, the service modules and the service configuration files of the SDK;
receiving, by the cloud server, an interaction request sent by the application;
parsing, by the cloud server, a system type of the application and a version of the SDK;
sending, by the cloud server, the service modules and/or the service configuration files to a terminal associated with the application and including the SDK based on the system type of the application and the version of the SDK; and
upgrading, by the cloud server, the SDK of the application.

2. The method of claim 1, wherein the act of configuring the service modules and service configuration files of the SDK comprises:
defining standardized data structures based on interface standards of an operating system corresponding to the application;
configuring the service modules of the application;
generating the service configuration files using (i) languages supported by the operating system corresponding to the application, and (ii) the standardized data structures; and
storing the service modules and the service configuration files in the cloud server.

3. The method of claim 2, wherein the service module is provided with a standardized data access interface application programming interface (API) through which the SDK of the application interacts with the service module.

4. The method of claim 1, wherein the service module comprises a plug-in service management module corresponding to an SDK of an Android system and/or a service module corresponding to an SDK of an iOS system written in the JavaScript language, and
wherein the service profile comprises a profile corresponding to the plug-in service management module and/or a JavaScript file corresponding to the SDK of the iOS system, and further comprising:
sending the JavaScript file to an iOS terminal including the SDK to upgrade the SDK of the application when the system type of the application is iOS; and
sending the plug-in service management module and the profile to an Android terminal including the SDK to upgrade the SDK of the application when the system type of the application is Android.

5. The method of claim 4, wherein the service module corresponding to the SDK of the iOS system comprises at least one of advertising, statistics, user interface (UI) composition, service side request sending, data standardization, and adaptation function modules, and
wherein the plug-in service management module comprises plug-ins corresponding to the respective functional modules of the SDK of the Android system.

6. An electronic device for upgrading a software development kit (SDK) of an application comprising at least one processor and a memory communicably connected with the at least one processor for storing instructions therein executable by the at least one processor, wherein execution of the instructions by the at least one processor causes the at least one processor to:
configure service modules and service configuration files of the SDK;
renew the service modules and the service configuration files;
receive an interaction request sent by the application;
parse a system type of the application and a version of the SDK;
send the service modules and/or the service configuration files to a terminal associated with the application and including the SDK based on the system type of the application and the version of the SDK; and
upgrade the SDK of the application.

7. The electronic device of claim 6, wherein execution of the instructions by the, at least one processor further causes the at least one processor to:
define standardized data structures based on interface standards of an operating system corresponding to the application;
configure the service modules of the application;
generate the service configuration files using (i) languages supported by the operating system corresponding to the application, and (ii) the standardized data structures; and
store the service modules and the service configuration files in the memory.

8. The electronic device of claim 7, wherein the service module is provided with a standardized data access interface application programming interface (API) through which the SDK of the application interacts with the service module.

9. The electronic device of claim 6, wherein the service module comprises a plug-in service management module corresponding to a SDK of an Android system and/or a service module corresponding to a SDK of an iOS system written in the JavaScript language,
wherein the service profile comprises a profile corresponding to the plug-in service management module and/or a JavaScript file corresponding to the SDK of the iOS system, and
wherein execution of the instructions by the at least one processor further causes the at least one processor to:
send the JavaScript file to an iOS terminal including the SDK to upgrade the SDK of the application when the system type of the application is iOS; and
send the plug-in service management module and the profile to an Android terminal including the SDK to upgrade the SDK of the application when the system type of the application is Android.

10. The electronic device of claim 9, wherein the service module corresponding to the SDK of the iOS system comprises at least one of advertising, statistics, user interface (UI) composition, service side request sending, data standardization, and adaptation function modules, and
wherein the plug-in service management module comprises plug-ins corresponding to the respective functional modules of the SDK of the Android system.

11. A non-transitory computer-readable storage medium storing executable instructions therein that, when executed by one or more processors associated with an electronic device, cause the electronic device to:
configure service modules and service configuration files of the SDK;
renew the service modules and the service configuration files;
receive an interaction request sent by the application;
parse a system type of the application and a version of the SDK;
send the service modules and/or the service configuration files to a terminal associated with the application and including the SDK based on the system type of the application and the version of the SDK; and
upgrade the SDK of the application.

12. The non-transitory computer-readable storage medium of claim 11, wherein execution of the instructions by the electronic device further causes the electronic device to:
define standardized data structures based on interface standards of an operating system corresponding to the application;
configure the service modules of the application and generate the service configuration files using (i) languages supported by the operating system corresponding to the application and, (ii) the standardized data structures; and
store the service modules and the service configuration files.

13. The non-transitory computer-readable storage medium of claim 12, wherein the service module is provided with a standardized data access interface application programming interface (API) through which the SDK of the application interacts with the service module.

14. The non-transitory computer-readable storage medium of claim 11, wherein the service module comprises a plug-in service management module corresponding to a SDK of an Android system and/or a service module corresponding to a SDK of an iOS system written in the JavaScript language,
wherein the service profile comprises a profile corresponding to the plug-in service management module and/or a JavaScript file corresponding to the SDK of the iOS system;
and wherein execution of the instructions by the electronic device further causes the electronic device to:
send the JavaScript file to an iOS terminal including the SDK to upgrade the SDK of the application when the system type of the application is iOS; and
send the plug-in service management module and the profile to an Android terminal including the SDK to upgrade the SDK of the application when the system type of the application is Android.

15. The non-transitory computer-readable storage medium of claim 14, wherein the service module corresponding to the SDK of the iOS system comprises at least one of advertising, statistics, user interface (UI) composition, service side request sending, data standardization, and adaptation function modules; and
the plug-in service management module comprises plug-ins corresponding to the respective functional modules of the SDK of the Android system.
